(19) United States
(12) Patent Application Publication
(10) Pub. No.: US 2005/0244112 A1
(43) Pub. Date: Nov. 3, 2005

(54) Optical fibre connector with shape memory properties

(75) Inventors: Michel Bugaud, Argentevil (FR); Patrick Olier, Chatillon (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, Paris 15eme (FR)

(21) Appl. No.: 10/529,475

(22) PCT Filed: Sep. 26, 2003
(86) PCT No.: PCT/FR03/50070

§ 371 Date: Mar. 28, 2005

(30) Foreign Application Priority Data
Sep. 30, 2002 (FR) 0212060

(51) Int. Cl. G02B 6/255

(52) U.S. Cl. 385/99

(57) ABSTRACT

This connector comprises a at least one shape memory means, comprising a first sleeve (14) made of a shape memory material and a second sleeve (16) made of an elastic material. The sleeves are coaxial and capable of applying radial forces on each other to fix or to release the ends (6, 8) of the fibers. The difference Sm1×Mm1−Sm2×Mm2, where Sm1 and Sm2 represent the cross sections of the sleeves and Mm1 and Mm2 represent their corresponding moduli of elasticity, is negative, when the first sleeve is in its martensitic phase, and positive when this first sleeve is in its austenitic phase.

### TECHNICAL DOMAIN

This invention relates to an optical fiber connector, more simply called an “optical connector” in the remainder of this description.

It is particularly applicable to the domain of optical telecommunications.

### STATE OF PRIOR ART

An optical connector including a first optical plug into which one end of a first optical fiber is placed, a second optical plug into which an end of a second optical fiber is placed, and an intermediate device designed to assemble the first and second optical plugs to each other such that the corresponding faces of the ends of the optical fibers are facing each other and these ends are made coaxial with high precision.

This type of connector requires very high precision machining of the first and second plugs and the assembly device for these plugs.

This connector uses three mechanical connections between the two fibers, namely a connection between the first fiber and the first plug, a connection between the first and second plugs, and a connection between the second plug and the second fiber.

It is obvious that positioning errors in these three connections will be algebraically additional to each other.

The required precision is essential for single mode optical fibers including cores with diameters of the order of 5 μm to 10 μm.

Thus, known connectors of the type described below are expensive, particularly when they are intended for connection of single mode optical fibers.

In particular, refer to the following document:
[1] U.S. Pat. No. 4,743,084 (R. M. Manning).

This document describes an optical plug comprising a sleeve made of a shape memory material capable of immobilizing the end of the optical fiber associated with this optical plug.

### PRESENTATION OF THE INVENTION

The purpose of this invention is an optical connector that does not require such a high machining precision as the known connector mentioned above, and that is therefore less expensive than this known connector.

The performances of the connector according to the invention can be similar to the performances of this known connector, but it is less expensive.

To achieve this, the invention uses a shape memory means capable of immobilizing and aligning the corresponding ends of two optical fibers.

Precisely, the purpose of this invention is an optical connector, this connector comprising at least a shape memory means, this shape memory means being capable of:
deforming by passing from a first state to a second state by changing the temperature of this shape memory means,
when it is in the first state, holding the corresponding ends of two optical fibers in a position in which the corresponding faces of these ends are facing each other, and
fixing these corresponding ends in this position while making these ends coaxial, when it is in the second state,
this connector being characterized in that the shape memory means comprises a first sleeve made of a shape memory material and a second sleeve made of an elastic material, the first sleeve thus possibly being in a martensitic phase or an austenitic phase depending on the temperature of this first sleeve, the first sleeve and the second sleeve being coaxial and capable of applying radial forces on each other to fix or to release the ends of the optical fibers, the empirical relation expressing the difference Sm1×Mm1−Sm2×Mm2, where Sm1 and Sm2 represent the corresponding cross sections of the first and second sleeves and Mm1 and Mm2 represent the corresponding moduli of elasticity of these first and second sleeves respectively, being negative when the first sleeve is in its martensitic phase and positive when this first sleeve is in its austenitic phase.

According to one preferred embodiment of the connector according to the invention, the connector of the first and second sleeves closest to the corresponding ends of the optical fibers comprises an inner face through which these corresponding ends are fixed, this inner face comprising means of bringing these ends towards each other when they are being fixed.

Preferably, the means of bringing the ends together are located on a single side of the inner face corresponding to one of the corresponding ends of the optical fibers, and can push this end in the longitudinal direction towards the other end.

In this case, the means of bringing the ends together preferably include saw tooth indentations.

According to a first particular embodiment of the connector according to the invention, the second sleeve is placed inside the first sleeve, this first sleeve being capable of applying pressure on the second sleeve to fix the ends of the optical fibers in position when this first sleeve is in the austenitic state, the second sleeve being capable of applying pressure on the first sleeve and releasing these ends when this first sleeve is in the martensitic state.

According to a second particular embodiment, the first sleeve is placed inside the second sleeve, this second sleeve being capable of applying pressure on the first sleeve to fix the ends of the optical fibers when this first sleeve is in the martensitic state, the first sleeve being capable of applying pressure on the second sleeve and releasing these ends when this first sleeve is in the austenitic state.

The elastic material from which the second sleeve is made may be a polymer.

The first sleeve may be in the form of a tube that is continuous or split longitudinally, or it may be perforated. It may also be made of a wire made of a shape memory material, this wire being wound or stitched or woven.

The connector according to the invention may include a plurality of copies of the shape memory means that are rigidly fixed to each other and designed to connect a plurality of optical fibers to a plurality of other corresponding optical fibers.

### BRIEF DESCRIPTION OF THE FIGURES

This invention will be better understood after reading the description of example embodiments given below, purely for guidance and in no way limitative, with reference to the appended figures, wherein:

FIGS. 1A and 1B show diagrammatic longitudinal sectional views of a first particular embodiment of the optical connector according to the invention, before (FIG. 1A) and after (FIG. 1B) immobilization and alignment of the optical fibers,

FIGS. 2A and 2B show diagrammatic cross-sectional views of the first particular embodiment of the optical connector according to the invention, FIG. 2A showing the state in which it enables immobilization and alignment of the optical fibers, and FIG. 2B showing the state in which it enables insertion of the fibers,

FIGS. 3A to 3D show diagrammatic perspective views of examples of the sleeve made of a shape memory material, that can be used in the invention,

FIG. 4 shows a diagrammatic longitudinal sectional view of a variant embodiment of the optical connector in FIGS. 1A and 1B,

FIGS. 5A and 5B show diagrammatic cross-sectional views of a second particular embodiment of the optical connector according to the invention, FIG. 5A showing the state in which it enables immobilization and alignment of the optical fibers, and FIG. 5B showing the state in which it enables insertion of the fibers,

FIG. 6A shows a diagrammatic perspective view of a connector according to the invention, used to connect a plurality of optical fibers to another plurality of optical fibers, and

FIG. 6B shows a diagrammatic and partial perspective view of a variant embodiment of the connector in FIG. 6A.

### DETAILED PRESENTATION OF PARTICULAR EMBODIMENTS

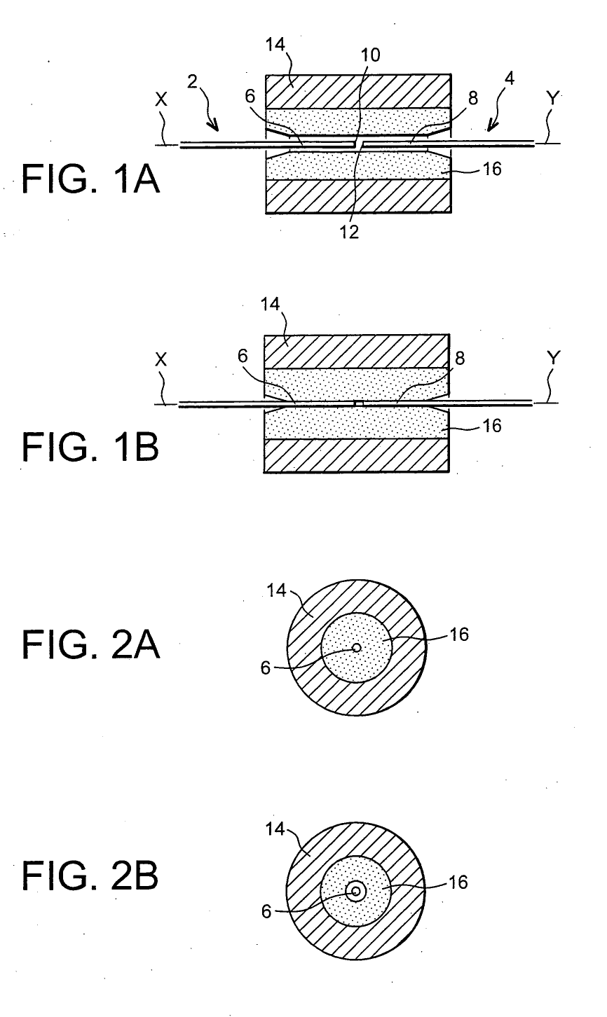

The optical connector according to the invention that is diagrammatically shown in FIGS. 1A, 1B, 2A and 2B, is designed to connect two optical fibers 2 and 4 such that the corresponding ends 6 and 8 of these fibers 2 and 4 are coaxial, the corresponding axes X and Y of these ends 6 and 8 then being coincident, and the corresponding faces 10 and 12 of these two ends 6 and 8 are facing each other as can be seen in FIGS. 1A and 1B.

This connector includes a first sleeve 14 made of a shape memory material. For example, this material may be a Tiny alloy. However, any other shape memory material can be used in this invention.

The connector also comprises a second sleeve 16 made of an elastic material such as a polymer, for example a polyimide.

The sleeves 14 and 16 are coaxial. The outside diameter of the sleeve that is surrounded by the other sleeve is equal to the inside diameter of the sleeve surrounding it, and the inside diameter equal to or slightly greater than the diameter of the optical fibers.

In the example in FIGS. 1A and 1B, the sleeve made of a shape memory material 14 surrounds the sleeve made of an elastic material 16.

Note that the protective casing on optical fibers can be left on the ends when assembling the ends in the connector, or this protective casing may be removed from these ends.

Note also in FIGS. 1A, 1B, 4, 6A and 6B, that the faces of these ends are shown at a spacing from each other to make these figures easier to read, but in reality these faces are actually touching each other.

There may be a spacing between them, but in this case an index adapter liquid will be placed between them.

The following description contains clarifications about the sleeves 14 and 16 with reference to FIGS. 2A and 2B corresponding to a cross-section at the end 6 of the fiber 2.

Tr is the phase transition temperature of the shape memory material, in other words the temperature at which this material changes from the martensitic phase to the austenitic phase.

At high temperature (FIG. 2A), in other words at a temperature exceeding Tr which corresponds to the nominal state of the sleeve 14 in the position in which the fibres are connected, this sleeve 14 is in its shrunk state which compresses the inner sleeve 16 made of polymer.

Under the effect of this compression, the sleeve 16 fixes the ends 6 and 8 of the fibers in position. Note that the sleeve 14 is designed to apply sufficient pressure on the inner sleeve 16 so that this sleeve fixes these ends in place.

This is achieved by assuring that at temperature above Tr, the empirical relation expressing the difference Sm1×Mm1−Sm2×Mm2 is positive, where Sm1 is the cross section of the sleeve 14, Sm2 is the cross section of the sleeve 16, Mm1 is the modulus of elasticity of the sleeve 14, and Mm2 is the modulus of elasticity of the sleeve 16.

At low temperature (FIG. 2B), in other word at a temperature less than Tr, the modulus of elasticity of the shape memory material reduces. The sleeve 14 is expanded by the elastic action of the polymer sleeve 16, which may be associated with hydraulic or mechanical inflation.

To achieve this, steps are taken to assure that the difference mentioned above is negative at temperatures less than Tr.

Simply for guidance and in no way limitatively,
Tr is chosen to be =−30° C. for a sleeve 14 operational at between −15° C. and +85° C.;
for example, in the martensitic state, the inside diameter of the “solid tube” variant 14 of the sleeve is 2 mm and the outside diameter is 2.05 mm, and in the austenitic state the inside diameter is 1.94 mm and the outside diameter is 1.99 mm;
the outside diameter of the polymer sleeve 16 is 2 mm in the non-compressed state and 1.94 mm in the compressed state, and its inside diameter is 0.128 mm in the non-compressed state and 0.12 mm in the compressed state;
the modulus of elasticity of the sleeve 14 is equal to 25 to 45 GPa in the martensitic state, and 70 to 90 Gpa in the austenitic state, and the modulus of elasticity of the sleeve 16 is equal to 3 GPa;
the diameter of the optical fibers is 125 μm.

The low temperature (less than −30° C. in the above example) may be obtained in the field by using a commercially available vaporizer capable of creating a temperature of −50° C.

The polymer sleeve 14 may be kept expanded (at ambient temperature, for example for storage of the connector) by a rigid wire with an appropriate diameter (for example 150 μm in the example described above). This wire will be released and can be removed when the temperature drops below Tr. This wire will then be replaced by the optical fibers to be connected.

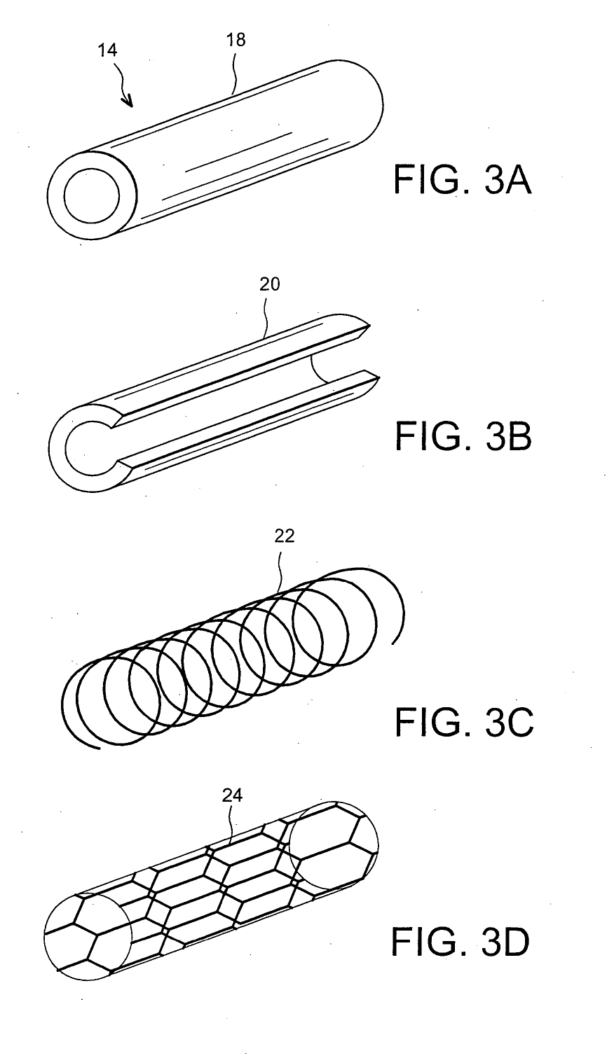

FIGS. 3A to 3D show diagrammatic perspective views of various possible shapes for the sleeve 14 made of the shape memory material.

This sleeve 14 may be in the form of a tube 18 (FIG. 3A), that is closed (around its periphery) or is in the shape of a longitudinally slit tube 20 (FIG. 3B) or it may be perforated (FIG. 3D).

The perforation percentage, as a percent of cross-section, will reduce the modulus of elasticity of the shape memory alloy sleeve proportionally, which will also modify the dimensions given as examples for a solid tube sleeve (FIG. 3A).

The sleeve 14 may also be made from a wound wire (helical) 22 made of a shape memory material (FIG. 3C) or a stitched or woven wire 24 made from a shape memory material (FIG. 3D).

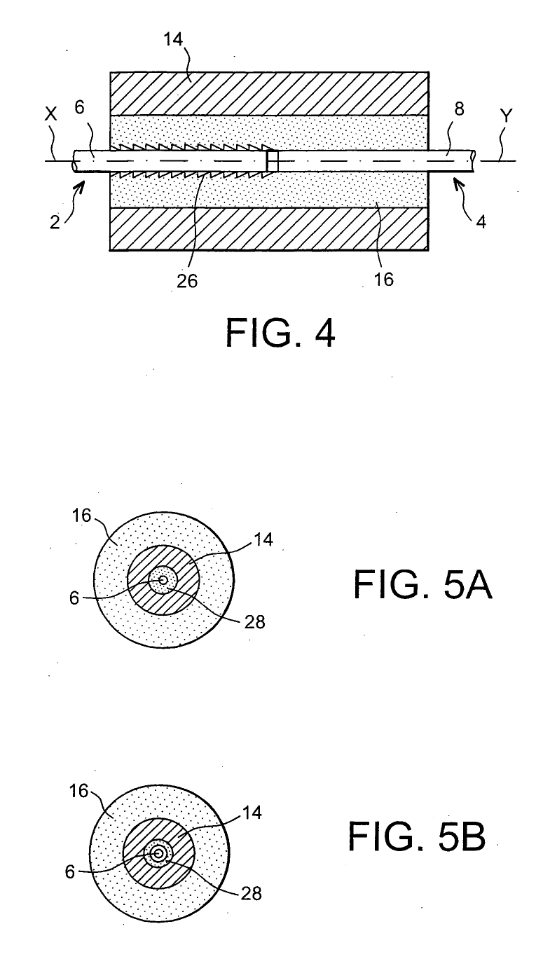

In one variant embodiment diagrammatically illustrated in FIG. 4, the inner wall of the sleeve 16 is provided with a thread forming saw tooth indentations 26.

This wire is preferably asymmetric, as shown in FIG. 4; it is formed from only one side of the inner sleeve 16 corresponding to one of the ends 6 and 8 of the fibers, namely the end 6 in the example.

When the temperature is greater than Tr, the wire applies a longitudinal pressure by compression on the end 6 of the fiber 2, to keep it in contact with the other end 8 of the fiber 4. The result is a sleeve 16 with positive action that improves optical coupling between these ends.

The result is thus a sleeve 16 with positive action that improves optical coupling between these ends.

Another example of a connector according to the invention is given below with reference to FIGS. 5A and 5B that correspond to a cross-section through the end 6 of the fiber 2.

In this other example, the sleeve 14 forms the inner sleeve; it is surrounded by the sleeve 16 that forms the outer sleeve.

The phase transition temperature of the shape memory material, in other words the temperature at which this material changes from the martensitic phase to the austenitic phase, is once again denoted Tr.

At low temperature (FIG. 5A), in other words at a temperature less than Tr, which in this case corresponds to the nominal state of the sleeve 14 in the position in which the fibers are connected, the sleeve 16 compresses the inner sleeve 14 that is ductile; it is in the martensitic phase.

Under the effect of this compression, this sleeve 14 fixes the ends 6 and 8 of the fibers. Note that the sleeve 16 is designed to apply sufficient pressure on the inner sleeve 14 so that this inner sleeve fixes these ends.

To achieve this, steps are taken such that at values below Tr, the difference Sm1×Mm1−Sm2×Mm2 is negative, where Sm1 is the cross section of the sleeve 14, Sm2 is the cross section of the sleeve 16, Mm1 is the modulus of elasticity of the sleeve 14, and Mm2 is the modulus of elasticity of the sleeve 16.

At high temperature (FIG. 5B), in other words at a temperature greater than Tr, the sleeve 14 is in its austenitic phase and applies a sufficient force on the sleeve 16 to expand it so that the ends 6 and 8 of the optical fibers can be inserted freely into this sleeve 14.

To achieve this, steps are taken such that the difference mentioned above is positive at temperatures greater than Tr.

An inner casing 28 made of polymer may be provided inside the sleeve 14, this casing being inserted between this sleeve 14 and the ends 6 and 8 of the fibers.

For guidance, and in no way limitatively
Tr is set equal to 125° C. for a sleeve 14 operational at less than 85° C.;
as an example, the inside diameter of this sleeve 14 will be 0.15 mm in the martensitic state and 0.145 mm in the austenitic state, and its outside diameter will be 0.350 mm in the martensitic state and 0.337 mm in the austenitic state;
the outside diameter of the polymer sleeve 16 will be 2 mm and its inside diameter will be 0.350 mm in the state in which it compresses the sleeve 14, and its outside diameter will be 1.99 mm and its inside diameter will be 0.337 mm in the state in which it is compressed by the sleeve 14;
the modulus of elasticity of the sleeve 14 in the martensitic state is equal to 25 to 45 GPa and 70 to 90 GPa in the austenitic state;
the modulus of elasticity of the sleeve 16 is equal to 3 GPa;
the thickness of the polymer casing 28 in the non compressed state is 12 μm;
the diameter of the optical fibers is 125 μm.

In the case shown in FIGS. 5A and 5B, the sleeve 14 may be in one of the forms mentioned in the description of FIGS. 3A to 3D.

Obviously, a combination of these two arrangements (FIGS. 1A-2A and 1B-2B) described above would also be possible to adapt the dimensions to the values of the moduli of elasticity of the shape memory alloy materials and of the chosen polymers.

Furthermore, the inner face of this sleeve 14 may also be provided with indentations on one side of the type described above with reference to FIG. 4.

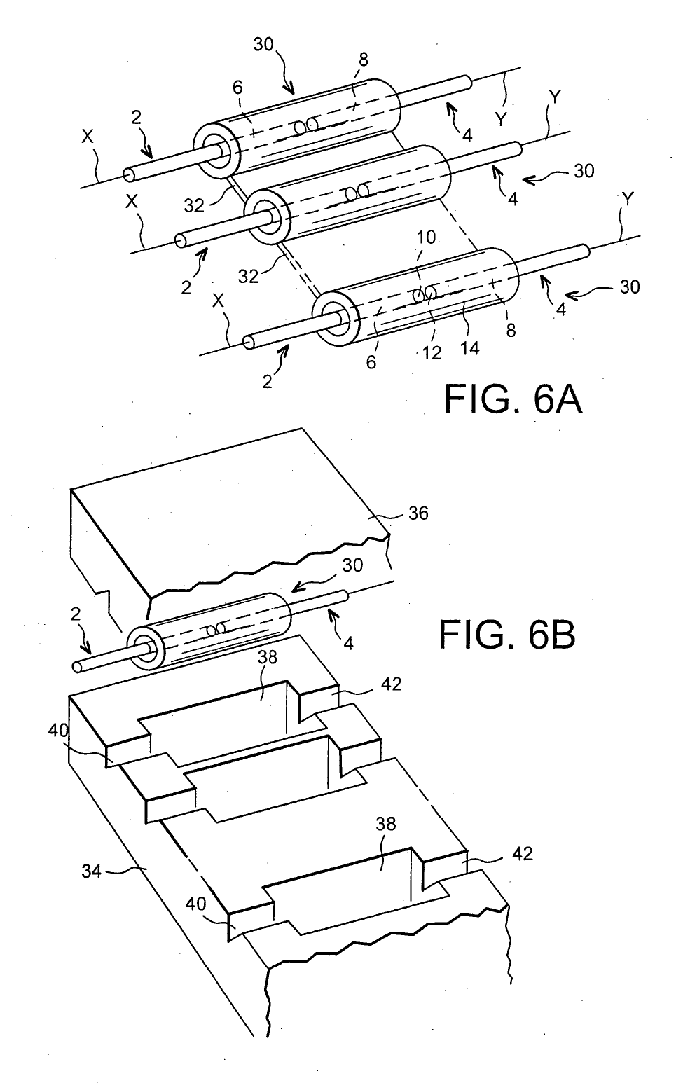

FIG. 6A shows a connector according to the invention comprising several connectors 30 of the type described above, for example with reference to FIGS. 1A and 1B.

These connectors 30 are rigidly fixed to each other by elements 32, for example made of stainless steel, such that the axes of the corresponding longitudinal drillings of the connector sleeves are parallel to each other.

Each of these connectors 30 is capable of connecting an optical fiber 2 to an optical fiber 4 such that the connector in FIG. 6A can optically connect a first set of optical fibers 2 to a second set of optical fibers 4.

FIG. 6B shows a partial perspective diagrammatic view of a variant embodiment of FIG. 6A in which the connectors 30 are rigidly fixed to each other by means of two identical plates 34 and 36, for example made of ceramic or glass, provided with parallel V shaped grooves.

Each groove comprises a portion 38 capable of accommodating one of the sleeves 14, and two portions 40 and 42 on each side of this portion 38 capable of accommodating the portions of fibers 2 and 4 located on each side of the sleeve considered.

1. Optical connector, this connector comprising at least a shape memory means (14, 18), this shape memory means being capable of:
deforming by passing from a first state to a second state by changing the temperature of this shape memory means,
when it is in the first state, holding the corresponding ends (6, 8) of two optical fibers (2,4) in a position in which the corresponding faces (10, 12) of these ends are facing each other, and
fixing these two corresponding ends in this position while making these ends coaxial, when it is in the second state,
this optical connector being characterized in that the shape memory means comprises a first sleeve (14) made of a shape memory material and a second sleeve (18) made of an elastic material, the first sleeve possibly being in a martensitic phase or an austenitic phase depending on the temperature of this first sleeve, the first sleeve and the second sleeve being coaxial and capable of applying radial forces on each other to fix or to release the ends (6, 8) of the optical fibers, the empirical relation expressing the difference Sm1×Mm1−Sm2×Mm2, where Sm1 and Sm2 represent the corresponding cross sections of the first and second sleeves (14, 16) and Mm1 and Mm2 represent the corresponding moduli of elasticity of these first and second sleeves respectively, being negative when the first sleeve is in its martensitic phase and positive when this first sleeve is in its austenitic phase.

2. Connector according to claim 1, in which the connector of the first and second sleeves (14, 16) closest to the corresponding ends (6, 8) of the optical fibers comprises an inner face through which these corresponding ends are fixed, this inner face comprising means (26) of bringing these ends towards each other when they are being fixed.

3. Connector according to claim 2, in which the means (26) of bringing the ends together are located on a single side of the inner face corresponding to one of the corresponding ends (6, 8) of the optical fibers, and can push this end in the longitudinal direction towards the other end.

4. Connector according to claim 3, in which the means of bringing the ends together preferably include saw tooth indentations (26).

5. Connector according to any one of claims 1 to 4, in which the second sleeve (16) is placed inside the first sleeve (14), this first sleeve being capable of applying pressure on the second sleeve to fix the ends of the optical fibers in position when this first sleeve is in the austenitic state, the second sleeve being capable of applying pressure on the first sleeve and releasing these ends when this first sleeve is in the martensitic state.

6. Connector according to any one of claims 1 to 4, in which the first sleeve (14) is placed inside the second sleeve (16), this second sleeve being capable of applying pressure on the first sleeve to fix the ends of the optical fibers when this first sleeve is in the martensitic state, the first sleeve being capable of applying pressure on the second sleeve and releasing these ends when this first sleeve is in the austenitic state.

7. Connector according to any one of claims 1 to 6, in which the elastic material from which the second sleeve (16) is made is a polymer.

8. Connector according to any one of claims 1 to 7, in which the first sleeve (14) is in the form of a tube (18, 20) that is continuous or split longitudinally, or perforated.

9. Connector according to any one of claims 1 to 7, in which the first sleeve (14) is made of a wire (22, 24) made of a shape memory material, this wire being wound or stitched or woven.

10. Connector according to any one of claims 1 to 9, including a plurality of copies (30) of the shape memory means that are rigidly fixed to each other and designed to connect a plurality of optical fibers (2) to a plurality of other corresponding optical fibers (4).
